(19) United States
(12) Patent Application Publication
(10) Pub. No.: US 2006/0002782 A1
(43) Pub. Date: Jan. 5, 2006

(54) Indicating fastener devices and methods of use therefor

(76) Inventor: Keith D. Elwell, Greenville, TX (US)

Correspondence Address: WILLIAM W. ENDERS;O'KEEFE,EGAN & PETERMAN, 1101 CAPITAL OF TEXAS HIGHWAY SOUTH, SUITE 200, AUSTIN, TX, 78746, US

(21) Appl. No.: 10/883,632

(22) Filed: Jul. 1, 2004

(51) Int. Cl. F16B 1/00

(52) U.S. Cl. 411/57.1

(57) ABSTRACT

Indicating fastener device that allows two or more sheet materials to be aligned and clamped together at a given fastener location while simultaneously being measured for appropriate fastener length at the given fastener location. The indicating fastener device may be implemented to have a variable or adjustable clamping dimension capability that allows for use with different stackup assemblies having varying overall thicknesses.

### BACKGROUND OF THE INVENTION

1. Field of the Invention

This invention relates generally to assembly of material layers, and more particularly to fabrication of items from multiple layers of sheet material.

2. Description of the Related Art

In the fabrication of aircraft components, multiple layers of sheet material, such as aircraft skin and doubler materials, are typically assembled together using permanent fasteners, such as rivets, that are received through small openings in the sheet material to secure the individual layers together into a common assembly. Until final assembly, conventional spring-loaded or draw-type temporary panel retainers are useful in keeping the various layers of sheet materials temporarily aligned and clamped together at small holes that are defined in the sheet material layers, pending enlargement of the holes for final assembly using permanent fasteners. Differing layer thicknesses and varying stackup configurations at different areas of the assembly mean that differing lengths of permanent fasteners may be required to secure different areas of the assembly.

Grip gages have been developed for measuring the thickness of assembled layers of sheet material to determine the length of permanent fastener that should be employed. However, such grip gages are designed to be inserted into the openings in the sheet material, thus requiring removal of a corresponding temporary panel retainer for measurement of material thickness. When the layers do not remain aligned and/or clamped together after removal of the temporary panel retainer, the measured permanent fastener length may be false. There are a variety of reasons why surfaces of multiple layers of materials often do not fit flush together. For example, gaps between multiple layers may exist due to differing part contour(s), excessive sealant existing between layers that has not yet been squeezed out, etc. Existence of such gaps between material layers may lead to false thickness measurements by conventional grip gages and to incorrect fastener length selection. Incorrect permanent fastener length selection translates into time and materials being wasted while installing and removing/destroying the incorrectly-sized fastener. In this regard, some permanent fasteners are relatively expensive. Furthermore, removal of permanent fasteners also risks costly damage to one or more layers of the structure.

FIG. 1 illustrates a conventional spring-loaded temporary panel retainer 110 having a main body 116 and nose assembly 160 that includes neck segments 131 and 133 and nose segments 132 and 134. In FIG. 1, neck segments 131 and 133 of nose assembly 160 are shown protruding through opening 140 defined in three sheet materials 120, 122, 124 of a stackup assembly that are temporarily aligned and clamped together by virtue of pressure exerted on the back surface 121 of sheet 120 by nose segments 132 and 134 of nose assembly 160, and on the front surface 125 of sheet 124 by shoulder area 118 of main body 116. As shown, stationary piece 130 is fixedly attached to body 116 that maintains separation of nose segments 132 and 134 so that nose segments 132 and 134 will not fit back through opening 140. Not shown is an internal spring that acts to retract nose and neck segments of nose assembly 160 toward body 110 so as to clamp sheet materials 120, 122 and 125 between main body 116 and nose segments 132 and 134. FIG. 1 also shows plunger 114 that internally contacts nose assembly 160, and is operable to extend nose assembly 160 away from back surface 121 of sheet 120 when depressed in the direction indicated by the arrow. A space is created between nose segments 132 and 134 when they are extended far enough so that they are no longer in a position proximate to stationary piece 130. This space allows nose segments 132 and 134 to come together so that they may pass though opening 140, allowing retainer 110 to be withdrawn from engagement with opening 140. Also shown in FIG. 1 is shoulder segment 112 that is provided to facilitate grip of retainer 110 for purposes of depressing assembly extension actuator 114.

### SUMMARY OF THE INVENTION

Disclosed herein are apparatus and methods that allow two or more sheet materials to be aligned and clamped together at a given fastener location while simultaneously being measured for appropriate fastener length at the given fastener location. Advantageously, the disclosed apparatus and methods may be so employed to help prevent incorrect fastener length selection, and thus to avoid costly installation problems that may result from attempted installation of fasteners having incorrect length. At the same time, the disclosed apparatus and methods may be implemented to have a variable or adjustable clamping dimension capability that allows for use with different stackup assemblies having varying overall thicknesses. By providing simultaneous clamping action and measurement capabilities, the disclosed apparatus and methods may be employed in a manner that eliminates the need for separate measurement steps using separate measurement devices, such as grip gages.

In one respect, disclosed herein is an indicating fastener device that includes a fastener body, a fastener extension and retention mechanism slidably received within the fastener body, and a thickness indicator configured to indicate a position of the fastener extension and retention mechanism relative to the fastener body. The thickness indicator may include a graduated scale, and the graduated scale may be disposed on at least one of the fastener body or the fastener extension and retention mechanism. In one exemplary embodiment, the fastener extension and retention mechanism may be configured with at least one retention member on an insertion end and with an actuator extension on an actuation end. In such an embodiment, a graduated scale may be disposed on the actuator extension. In another embodiment, the external dimensions of the indicating fastener device may be configured to correspond to the external dimensions of a conventional temporary panel retainer. In yet another embodiment, the thickness indicator may include an electronic indicator.

In another respect, disclosed herein is an indicating fastener device that includes: a fastener body having a proximal end and a distal end, the fastener body having an internal opening defined therein between the proximal end and the distal end; a fastener extension and retention mechanism slidably received within the internal opening of the fastener body, the fastener extension and retention mechanism having an insertion end that may be received adjacent the proximal end of the fastener body and an actuation end that may be received adjacent the distal end of the fastener body, and further including at least one retention member provided on the insertion end and an actuator extension provided on the actuation end; and a thickness indicator provided on the fastener extension and retention mechanism. The fastener extension and retention mechanism may further include at least one extension member positioned between the retention member and the actuator extension, and the insertion end of the fastener extension and retention mechanism may be dimensionally configured to be extendable from the proximal end of the fastener body and to be received through an opening defined in at least one sheet of material (e.g., a stack up assembly of two or more sheets of material) having a back surface and a front surface such that the at least one extension member extends through the opening from the front surface to the back surface and such that the retention member may be positioned adjacent the back surface when the proximal end of the fastener body may be positioned adjacent the front surface. The at least one retention member may be configured to selectably engage the back surface of the at least one sheet of material in retaining relationship at the same time that the proximal end of the fastener body contacts the front surface of the at least one sheet of material, and the thickness indicator may be configured to move with the fastener extension and retention mechanism relative to the fastener body so as to indicate the distance between the front surface and the back surface of the at least one sheet of material when the retention member engages the back surface of the at least one sheet of material in retaining relationship at the same time that the proximal end of the fastener body contacts the front surface of the at least one sheet of material.

In one embodiment, the indicating fastener device of claim may further include a retraction mechanism configured to bias the fastener extension and retention mechanism in a direction that retracts the insertion end of the fastener extension and retention mechanism toward the proximal end of the fastener body so as to clamp the at least one sheet of material between the retention member and the proximal end of the fastener body when the at least one retention member engages the back surface of the at least one sheet of material in retaining relationship at the same time that the proximal end of the fastener body contacts the front surface of the at least one sheet of material. The actuator extension may extend from the distal end of the fastener body when the insertion end of the fastener extension and retention mechanism is retracted toward the proximal end of the fastener body. The fastener extension and retention mechanism may include at least two retention members provided on the insertion end of the fastener extension and retention mechanism that may include, for example, first and second opposing tang segments. A first extension member may be provided between the first tang segment and the actuator extension and a second extension member may be provided between the second tang segment and the actuator extension, the first and second extension members being biased toward each other and deflectable away from each other to form a space therebetween. The indicating fastener device may further include a separating member received in the space between the first and second extension members, the separating member configured to extend from the proximal end of the fastener body so as to as to be disposed adjacent and between the first and second tang segments when the first and second tang segments engage the back surface of the at least one sheet of material in retaining relationship at the same time that the proximal end of the fastener body contacts the front surface of the at least one sheet of material so that the insertion end of the fastener extension and retention mechanism has an external dimension that may be greater than the diameter of the opening defined in the at least one sheet of material.

In another respect, disclosed herein is a method of determining the thickness of at least one sheet of material, the method including providing an indicating fastener device, the indicating fastener device that includes: a fastener body having a proximal end and a distal end, a fastener extension and retention mechanism slidably received within the fastener body and having an insertion end extending from the proximal end of the fastener body and having a retention mechanism provided thereon, and a thickness indicator configured to indicate a position of the fastener extension and retention mechanism relative to the fastener body. The method may include positioning the insertion end of the fastener extension and retention mechanism within an opening defined in the at least one sheet of material and in operative relationship with the fastener body so that the retention mechanism selectably engages a back surface of the at least one sheet of material (e.g., a stack up assembly of at least two sheets of material) at the same time the proximal end of the fastener body contacts a front surface of the at least one sheet of material such that the position of the fastener extension and retention mechanism relative to the fastener body corresponds to the thickness of the at least one sheet of material, and determining the thickness of the at least one sheet of material from the thickness indicator. In one embodiment, the method may further include selectably clamping at least two sheet materials of a stack up assembly together between the retention mechanism of the fastener extension and retention mechanism and the proximal end of the fastener body so that substantially no gap exists between the at least two sheet materials of the stack up assembly. The method may also further include disengaging the retention mechanism of the fastener extension and retention mechanism from the back surface of the at least two sheet materials of the stack up assembly; and removing the insertion end of the fastener extension and retention mechanism from the opening defined in the at least two sheet materials of the stack up assembly. A permanent fastener may be selected based at least in part on the determined thickness of the at least two sheets of material of the stack up assembly; the at least two sheets of material of the stack up assembly assembled together using the selected permanent fastener.

### BRIEF DESCRIPTION OF THE DRAWINGS

FIG. 1 is a simplified side view of a conventional panel retainer.

FIG. 2A is a simplified and partial cut-away side view of an indicating fastener device according to one embodiment of the disclosed apparatus and methods.

FIG. 2B is a simplified side view of a fastener extension and retention mechanism according to one embodiment of the disclosed apparatus and methods.

FIG. 2C is a simplified cut-away side view of a fastener extension and retention mechanism according to one embodiment of the disclosed apparatus and methods.

FIG. 2D is a simplified cut away side view of the proximal end of the fastener extension and retention mechanism of FIG. 2C.

FIG. 2E is a side view of a separating member assembly according to one embodiment of the disclosed apparatus and methods.

FIG. 2F is a top view of the separating member assembly of FIG. 2E.

FIG. 2G is an end view of a separating member retainer according to one embodiment of the disclosed apparatus and methods.

FIG. 2H is a top view of the separating member retainer of FIG. 2G.

FIG. 2I is a side view of the separating member retainer of FIG. 2G.

FIG. 3 is a simplified side view of an indicating fastener device according to one embodiment of the disclosed apparatus and methods.

FIG. 4 is a simplified side view of an indicating fastener device according to one embodiment of the disclosed apparatus and methods.

FIG. 5 is a simplified side view of an indicating fastener device according to one embodiment of the disclosed apparatus and methods.

FIG. 6 is a simplified side view of an indicating fastener device according to one embodiment of the disclosed apparatus and methods.

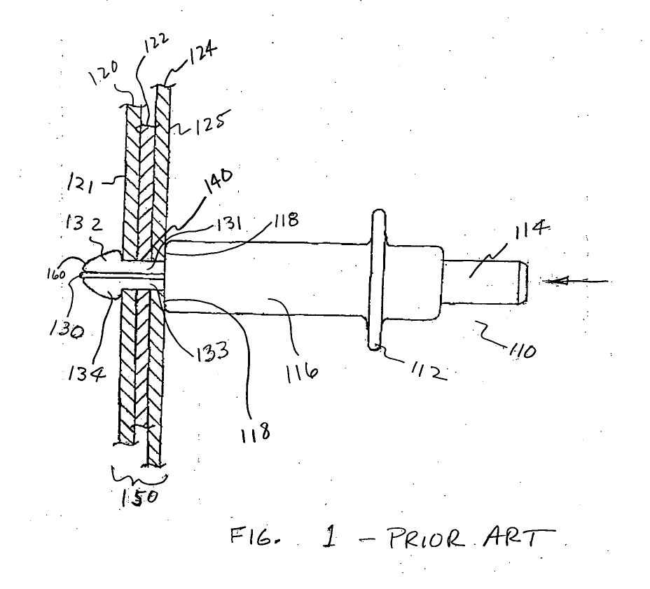

### DESCRIPTION OF ILLUSTRATIVE EMBODIMENTS

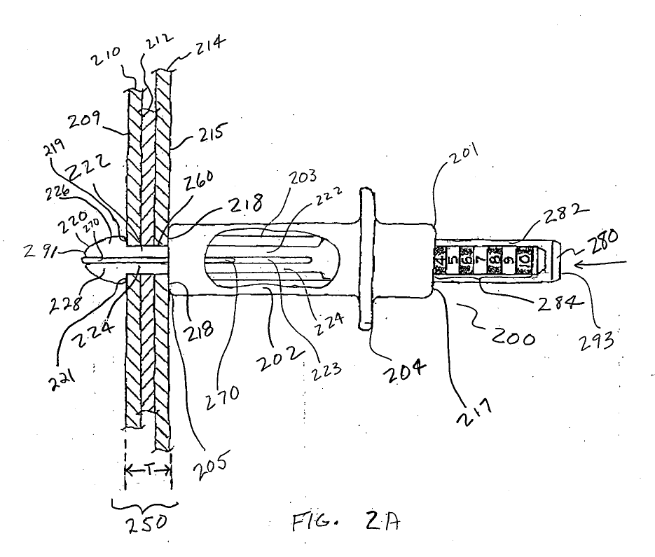

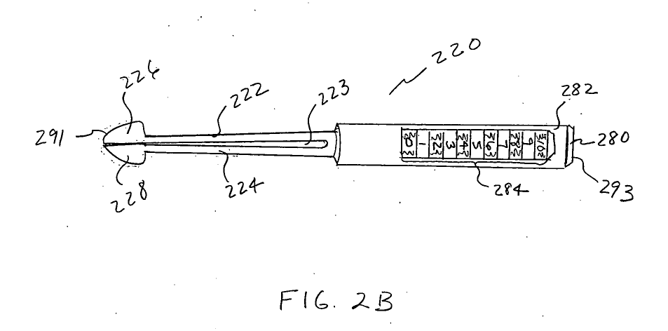

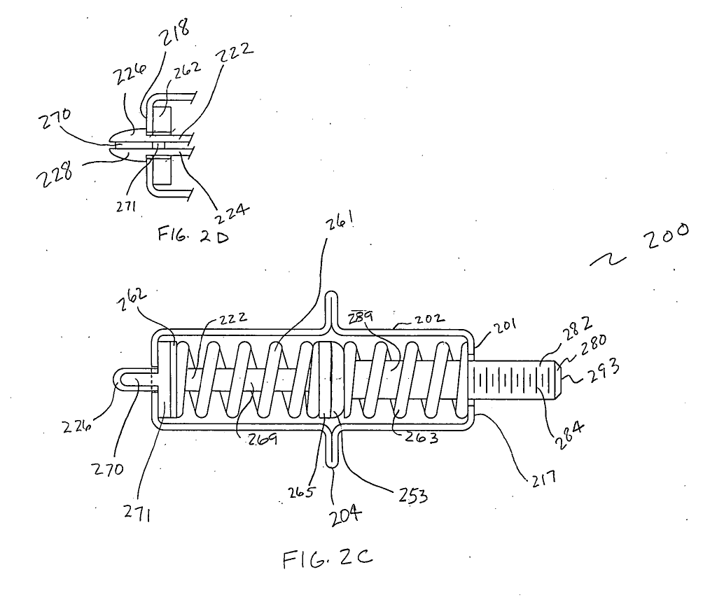

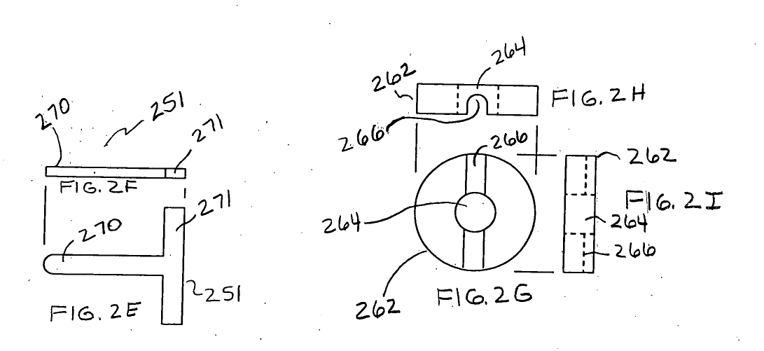

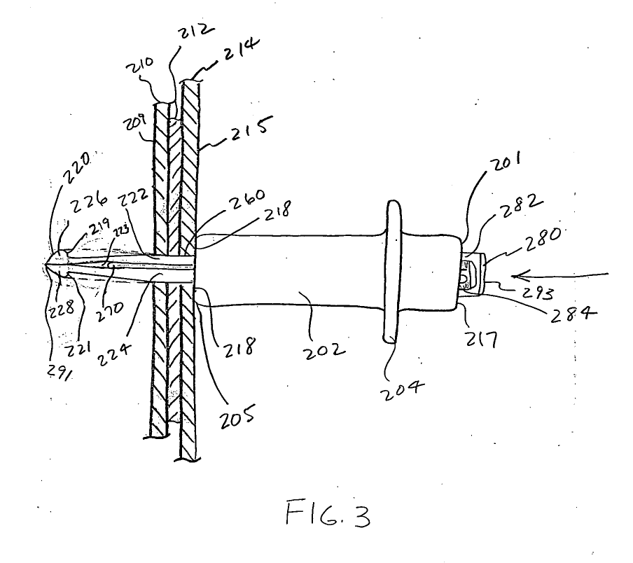

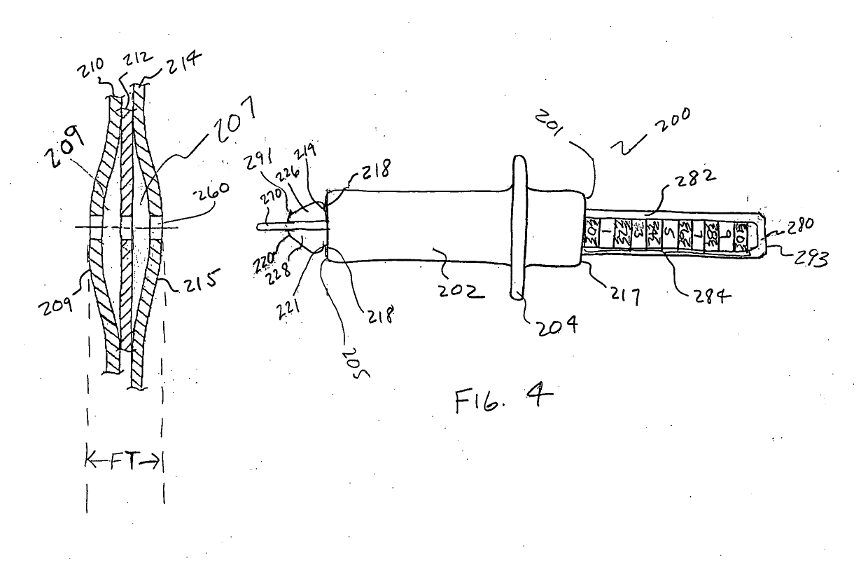

FIG. 2A illustrates one embodiment of an indicating fastener device 200 shown in operable relation to a plurality of assembled sheet materials 210, 212 and 214 that are assembled in FIG. 2A to form a stackup assembly 250. In this exemplary embodiment, indicating fastener device 200 is configured with a fastener body 202 having an internal opening 203 defined therein that is centered along the longitudinal axis of body 202 between proximal end 205 and distal end 201 of body 202 as indicated in the cut-away section of FIG. 2A. As shown in FIG. 2A, internal opening 203 is configured to slidably receive a fastener extension and retention mechanism 220 that on an insertion end 291 includes extension members 222 and 224 and two opposed retention members in the form of tang segments 226 and 228, and that on an opposing actuation end 293 includes an actuator extension 280. As illustrated, extension members 222 and 224 are separate members that are deflectable away from each other to form a space 223 configured to receive separating member 270 for maintaining separation between extension members 222 and 224 as described further below.

FIG. 2B shows an exemplary fastener extension and retention mechanism 220 of the embodiment of FIG. 2A. As illustrated in FIG. 2B, extension members 222 and 224 (with tang segments 226 and 228) are biased against each other in the absence of separating member 270 positioned therebetween. FIGS. 2C-2I illustrate an exemplary embodiment of internal configuration for an indicating fastener device 200 that employs a multi-piece (e.g., two-piece) fastener extension and retention mechanism.

In FIG. 2A, extension members 222 and 224 of insertion and retention mechanism 220 are shown received in an opening 260 defined by individual aligned openings formed in respective multiple sheet materials 210, 212 and 214 of stackup assembly 250, e.g., for purposes of temporary clamping, alignment, measurement and/or other suitable purpose/s. As illustrated, a retention mechanism may be configured to selectably engage a back surface 209 of stackup assembly 250 in temporary retaining relationship. For example, in the illustrated embodiment, separating member 270 may be fixed to fastener body 202 and is provided to maintain separation of tang segments 226 and 228 so that tang segments 226 and 228 will remain sufficiently separated so that insertion end 291 has an expanded outer dimension that will contact back surface 209 and not fit through opening 260 when tang segments 226 and 228 are positioned proximate to separating member 270 as shown.

Although one exemplary embodiment of insertion and retention mechanism 220 is shown illustrated in FIGS. 2A and 2B, it will be understood that extension members 222 and 224 of insertion and retention mechanism 220 may be integrally formed with, or separately coupled to, actuator extension 280 in any manner suitable so that movement of extension members 222 and 224 relative to body 202 causes corresponding movement of actuator extension 280 relative to body 202. For example, extension members 222 and 224 and actuator extension 280 may be formed of a single piece of material (e.g., to form a single piece insertion and retention mechanism 220), or extension members 222 and 224 may be separate components that terminate against a separate actuator extension 280 component at a point within body 202 (e.g., to form a multi-piece insertion and retention mechanism 220). Alternatively, insertion and retention mechanism 220 may be a multi-piece assembly that includes extension members 222 and 224 coupled to actuator extension 280 by one or more other intermediate members that are internally and slidably disposed therebetween within body 202.

Not shown in FIG. 2A is a retraction mechanism (e.g., internal spring or other suitable biasing mechanism) that may be provided to retract extension members 222 and 224 (with tang segments 226 and 228) of insertion and retention mechanism 220 toward body 202 so as to clamp sheet materials 210, 212 and 214 between main body 202 and tang segments 226 and 228. In the illustrated embodiment, this clamping action is achieved by virtue of contact between tang segments 226, 228 and back surface 209 of stack up assembly 250 simultaneously with contact between proximal end 205 of fastener body 202 and front surface 215 of stack up assembly 250 in a manner as will be described further herein. It will be understood that a retraction mechanism may be any external and/or internal component/s suitably configured to retract or otherwise bias one or more retention members of an insertion and retention mechanism toward a fastener body so as to clamp sheet materials between the fastener body and the retention member/s.

FIG. 2C illustrates an exemplary embodiment of an indicating fastener device 200 that employs a two-piece fastener extension and retention mechanism assembly in the form of a proximal portion 269 and distal portion 289. A proximal spring collar 265 fixedly coupled to proximal portion 269 and a distal spring collar 253 fixedly coupled to distal portion 289 are shown provided between proximal and distal portions 269 and 289 in a manner that couples the spring force of respective springs 269 and 263 to the fastener extension and retention mechanism assembly relative to fastener body 202. As illustrated, proximal portion 269 includes tang segment 226 and extension member 222. Not shown in the cutaway view of FIG. 2C is corresponding tang segment 228 and extension member 224. FIG. 2D shows proximal end of indicating fastener device 200 of FIG. 2C from a cut-away view oriented perpendicular to the view of FIG. 2C, and thus illustrates both tang segments 226 and 228 and their respective extension members 222 and 224.

Still referring to FIGS. 2C and 2D, separating member 270 is provided as shown for separating extension members 222 and 224 in a manner as described elsewhere herein. In the illustrated exemplary embodiment, separating member 270 is provided as part of a separating member assembly 251 that includes a separating member base 271 that supports separating member 270, as further illustrated in FIGS. 2E and 2F. Separating member assembly 251 is dimensioned (e.g., formed to be relatively flat in profile) so as to allow sufficient room for tang segments 226 and 228, and extension members 222 and 224, to pass on opposing sides of separating member assembly 251 in the manner illustrated.

As shown in FIGS. 2C and 2D, separating member assembly 251 is received by a separating member retainer 262 that is positioned between proximal spring 261 and separating member assembly 251. Separating member retainer 262 is shown in greater detail in FIGS. 2G through 2I, and includes opening 264 that is suitably dimensioned for receiving tang segments 226 and 228, extension members 222 and 224, and separating member 270 that is positioned between segments 226 and 228 and members 222 and 224. A channel 266 is provided as shown for receiving separating member base 271.

Still referring to the embodiment of FIGS. 2C-2I, proximal spring 261 may be provided as a relatively stronger spring in relation to distal spring 263 that may be provided as a relatively weaker spring. In such a configuration, proximal spring acts as a retraction mechanism to retract extension members 222 and 224 (with tang segments 226 and 228) of proximal portion 269 toward body 202 by virtue of bias force exerted against proximal spring collar 265. Distal spring 263 may be optionally provided to maintain distal portion 289 (including actuator extension 280) in corresponding relation with proximal portion 269 as it moves by virtue of bias force exerted against distal spring collar 253. It will be understood that distal spring 263 and distal spring collar 253 may be absent, for example, when a single-piece fastener extension and retention mechanism 220 is employed such as illustrated in FIG. 2B.

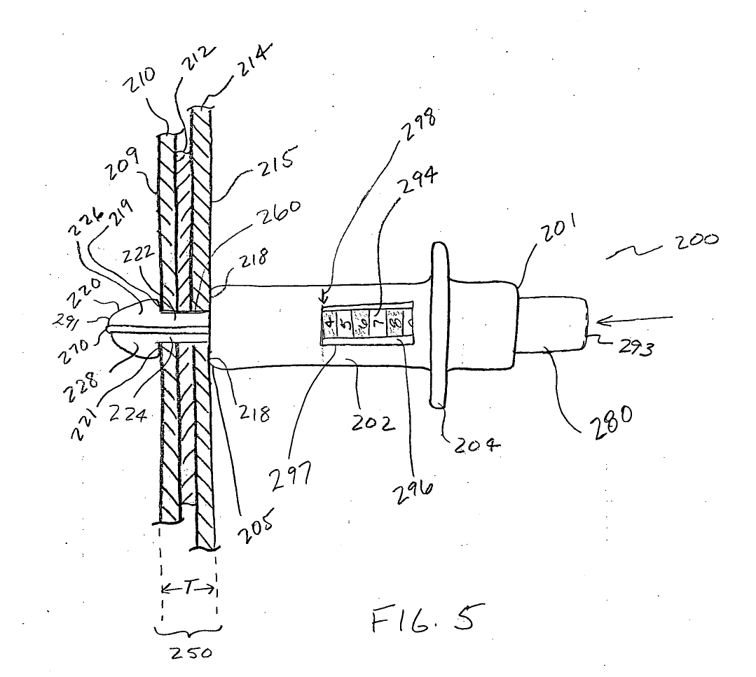

Referring now to FIG. 3, movement of actuation end 293 of insertion and retention mechanism 220 of this exemplary embodiment in the direction indicated by the arrow results in extension of insertion end 291 away from back surface 209 of sheet 210 to disengage tang segments 226 and 228 from back surface 209, e.g., when actuator extension 280 is depressed in the direction of the arrow. In a manner similar to a conventional panel retainer, tang segments 226 and 228 are allowed to deflect toward each other when they are extended far enough so that they are no longer in a position proximate to stationary separating member 270. This reduces the external dimensions of insertion end 291 of insertion and retention mechanism 220 so that it will pass though opening 260 as shown by the dashed lines in FIG. 3, allowing the entire fastener device 200 to be withdrawn from engagement with opening 260 while insertion end 291 is extended so that tang segments 226 and 228 are not in a position proximate to stationary separating member 270 as shown. A similar movement of actuation end 293 of insertion and retention mechanism 220 in the direction indicated by the arrow relative to fastener body 202 may be used to reduce the external dimensions of insertion end 291 of insertion and retention mechanism 220 so that it may be inserted into opening 260 or another opening of suitable dimension (e.g., an opening in a stack up assembly having a different thickness). In this manner, indicating fastener device 200 may be inserted and removed multiple times.

As shown in the figures, an optional shoulder member 204 may be provided to facilitate grip of fastener device 200 for purposes of depressing actuator end 293 of insertion and retention mechanism 220 using conventional temporary panel retainer release tools and/or methods. Thus, in one embodiment, a fastener device 200 may be provided that advantageously may be used interchangeably and/or in the place of conventional spring-loaded temporary panel retainers without requiring new tools and/or operational steps, while at the same providing unique stack up thickness measurement capabilities as described further herein. In such an exemplary embodiment, an indicating fastener device 200 may be provided that is configured with one or more of the thickness indicating features of the disclosed apparatus in combination with the same external dimensions and operating characteristics as a conventional temporary panel retainer, although this is not necessary to realize the benefits of the disclosed apparatus and methods. Furthermore, if desired, an indicating fastener device may additionally or alternatively be configured with one or more of the same or similar internal operating mechanism/s of a conventional panel retainer in combination with the thickness indicating features of the disclosed apparatus. Examples of conventional temporary panel retainers include, but are not limited to, “K” Series Temporary Fasteners (“Clecos”) available from Brown Aviation Tool Supply Company of Oklahoma City, Okla.

Referring again to FIG. 2A, when extension members 222 and 224 of insertion and retention mechanism 220 are received in opening 260, contact surface 218 of body 202 is positioned to make contact with front surface 215 of front sheet 214 while at the same time contact surfaces 219 and 221 of respective tang segments 226 and 228 are positioned to make contact with back surface 209 of back sheet 210. Retraction of extension members 222 and 224 toward body 202 (e.g., by suitable retraction mechanism) toward body 202 acts to selectably engage and clamp sheet materials 210, 212 and 214 between main body 202 and tang segments 226 and 228 when tang segments 226 and 228 are positioned proximate to separating member 270 while extending through opening 260 as shown. Because actuator extension 280 of insertion and retention mechanism 220 is coupled to move relative to body 202 in a manner corresponding to movement of extension members 222, 224 and tang segments 226, 228, the position of actuator extension 280 relative to body 202 is determined by the thickness “T” of stack up assembly 250. In the illustrated embodiment, this relationship allows determination of thickness “T” for a given stack up assembly 250 by using a thickness indicator that in this case includes a graduated scale 284 that is disposed on a surface 282 of actuator extension 280 so that scale 284 moves relative to body 202 in a corresponding manner with extension members 222, 224 and tang segments 226, 228. However, it will be understood that any other location may be employed for a graduated scale or other form of thickness indicator so that it moves in corresponding manner with extension members 222, 224 and tang segments 226, 228 relative to body 202, or so that it is otherwise operable to indicate thickness in a manner as will be described further herein.

In the illustrated exemplary embodiment of FIG. 2A, thickness of a stack up assembly (e.g., such as stack up assembly 250) may be determined by reading the position of graduated scale 284 relative to body 202. For example, as shown, graduated scale 284 may be read relative to a reference feature in the form of reference surface 217 of body 200. In this regard, FIG. 2A shows reference surface 217 positioned adjacent a thickness value between “3” and “4” on graduated scale 284. It will be understood that thickness values of a graduated scale may represent a recognized unit of measurement (e.g., millimeters, centimeters, fractions of an inch, etc.), or may be any other suitable configuration of indicator (e.g., arbitrary unit of measure, relative thickness indication, etc.) that corresponds to the distance between contact surfaces 219 and 221 of tang segments 226, 228 and contact surface 218 of body 202. Furthermore, although a reference surface 217 is illustrated in FIG. 2A, it will be understood that any other suitable configuration of reference feature may be employed that is provided on, or that is otherwise configured to maintain a constant position relative to fastener body 202 so that graduated scale 284 may be read in a manner that allows thickness of a stack up assembly to be determined.

FIG. 4 shows indicator fastener device 200 with fastener extension and retention mechanism 220 in fully retracted position relative to body 202. As illustrated in FIG. 4, indicator fastener device 200 may be configured so that when it is removed from stack up assembly 250, and extension members 222, 224 are fully retracted relative to body 202 so that contact surfaces 219 and 221 of tang segments 226 and 228 make contact with contact surface 218 of body 202, then indicator surface 217 will be positioned adjacent a value “0” on graduated scale 284. Also shown in FIG. 4 are sheet materials 210, 212 and 214 having gaps 207 and 209 therebetween. As illustrated, gaps 207 and 209 have formed in the absence of the clamping action provided by indicating fastener device 200, creating a false stack up assembly thickness of “FT” that may be inadvertently measured, for example, by a conventional grip gage when inserted through opening 260. In this regard gaps 207 and 209 are shown as they may exist prior to insertion of indicating fastener device 200 into opening 260, or after removal of indicating fastener device 200 from opening 260.

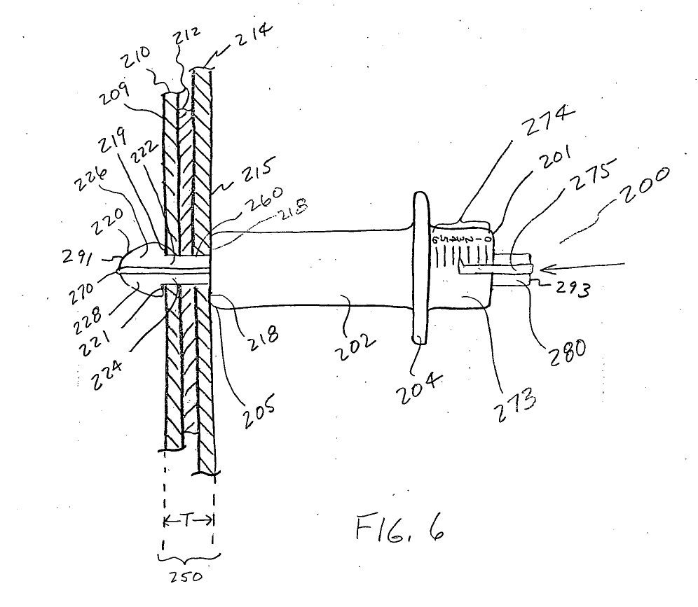

It will be understood that the illustrated graduated scale and corresponding reference feature embodiment described in relation to FIGS. 2-4 is exemplary only. In this regard, any other configuration of thickness indicator may be employed that is suitable for indicating an absolute or relative distance between contact surfaces 219 and 221 of tang segments 226, 228 and contact surface 218 of body 202. For example, FIG. 5 illustrates a thickness indicator that includes a graduated scale 294 disposed on an internal slidable member 296 (e.g., internal portion of fastener extension and retention mechanism 220, or internal slidable member/s that moves in corresponding manner with fastener extension and retention mechanism 220) that is positioned within body 202 of another exemplary embodiment of indicating fastener 200. As illustrated in FIG. 5, a window or cut-out section 297 may be defined within body 202 to allow the position of graduated scale 294 to be read relative to body 202 (e.g., using index marker 298 or other suitable reference feature). An actuator extension 280 is shown provided on actuation end 293 of fastener extension and retention mechanism 220 that is operable (e.g., with or without optional shoulder member 204) to extend insertion end 291 of insertion and retention mechanism 220 away from back surface 209 of sheet 210 when depressed in the direction indicated by the arrow in a manner as previously described herein.

FIG. 6 illustrates another exemplary embodiment of indicating fastener 200 that includes a thickness indicator in the form of a graduated scale 274 disposed on an external surface 273 of fastener body 202 and indicator feature in the form of indicator pointer 275 that is slidably and cooperatively positioned relative to graduated scale 274. As shown, indicator pointer 275 is coupled to actuator extension 280 on actuation end 293 of fastener extension and retention mechanism 220 so that that it moves in corresponding manner with fastener extension and retention mechanism 220 when actuator extension 280 is depressed in the direction indicated by the arrow in a manner as previously described herein so as allow the position of indicator pointer 275 to be read relative to body 202 (e.g., using graduated scale 274).

In yet another embodiment (not illustrated), a thickness indicator may be provided in the form of an electronic indicator (e.g., digital gauge responsive to movement of insertion and retention mechanism 220 relative to body 202). Such an electronic indicator may be implemented using any electronic device suitable for indicating position of insertion and retention mechanism 220 relative to body 202, e.g., proximity sensor, limit switch, etc. Such an electronic thickness indicator may be provided in any form and/or position relative to an indicating fastener body (e.g., as a digital display window on surface of indicator body 202) that is suitable for displaying stack up thickness information. As with other embodiments, such an embodiment may be implemented with an optional actuator extension that is operable (e.g., with or without optional shoulder member) to extend an insertion and retention mechanism of the indicating fastener in a manner as previously described herein.

It will be understood that the illustrated embodiments are exemplary only, and that other configurations are possible. For example, an indicating fastener device may be provided with any configuration of insertion and retention mechanism having an insertion end that is suitable for being extendably received through openings in one or more sheet materials. In this regard, an insertion and retention mechanism may be configured with a single retention member (e.g., a single tang segment with corresponding single extension member), or more than two retention members (e.g., three or more tang segments with corresponding extension members) may be provided. Furthermore, it will be understood that an insertion and retention mechanism may be configured to operate without the presence of a separating member. For example, an insertion and retention mechanism may be configured with a single tang segment that may be inserted through one or more sheet material opening/s so that it is offset relative to the center of the opening/s in a manner so that a contact surface of the single tang segment may be positioned to make contact with a back surface of the sheet material/s. Furthermore, it will be understood that one or more retraction mechanisms may be provided that are internal and/or external to a fastener body.

While the invention may be adaptable to various modifications and alternative forms, specific embodiments have been shown by way of example and described herein. However, it should be understood that the invention is not intended to be limited to the particular forms disclosed. Rather, the invention is to cover all modifications, equivalents, and alternatives falling within the spirit and scope of the invention as defined by the appended claims. Moreover, the different aspects of the disclosed apparatus and methods may be utilized in various combinations and/or independently. Thus the invention is not limited to only those combinations shown herein, but rather may include other combinations.

What is claimed is:

1. An indicating fastener device, comprising:
a fastener body;
a fastener extension and retention mechanism slidably received within said fastener body; and
a thickness indicator configured to indicate a position of said fastener extension and retention mechanism relative to said fastener body.

2. The indicating fastener device of claim 1, wherein said thickness indicator comprises a graduated scale.

3. The indicating fastener device of claim 1, wherein said graduated scale is disposed on at least one of said fastener body or said fastener extension and retention mechanism.

4. The indicating fastener device of claim 2, wherein said fastener extension and retention mechanism has an insertion end and an actuation end; and wherein said fastener extension and retention mechanism is configured with at least one retention member on said insertion end and with an actuator extension on said actuation end.

5. The indicating fastener device of claim 4, wherein said graduated scale is disposed on said actuator extension.

6. The indicating fastener device of claim 4, wherein said graduated scale is disposed on said actuator extension.

7. The indicating fastener device of claim 1, wherein said thickness indicator comprises an electronic indicator.

8. An indicating fastener device, comprising:
a fastener body having a proximal end and a distal end, said fastener body having an internal opening defined therein between said proximal end and said distal end;
a fastener extension and retention mechanism slidably received within said internal opening of said fastener body, said fastener extension and retention mechanism having an insertion end that is received adjacent said proximal end of said fastener body and an actuation end that is received adjacent said distal end of said fastener body, and further comprising at least one retention member provided on said insertion end and an actuator extension provided on said actuation end; and
a thickness indicator provided on said fastener extension and retention mechanism.

9. The indicating fastener device of claim 8, wherein said fastener extension and retention mechanism further comprises at least one extension member positioned between said retention member and said actuator extension;
wherein said insertion end of said fastener extension and retention mechanism is dimensionally configured to be extendable from said proximal end of said fastener body and to be received through an opening defined in at least one sheet of material having a back surface and a front surface such that said at least one extension member extends through said opening from said front surface to said back surface and such that said retention member is positioned adjacent said back surface when said proximal end of said fastener body is positioned adjacent said front surface;
wherein said at least one retention member is configured to selectably engage said back surface of said at least one sheet of material in retaining relationship at the same time that said proximal end of said fastener body contacts said front surface of said at least one sheet of material; and
wherein said thickness indicator is configured to move with said fastener extension and retention mechanism relative to said fastener body so as to indicate the distance between said front surface and said back surface of said at least one sheet of material when said retention member engages said back surface of said at least one sheet of material in retaining relationship at the same time that said proximal end of said fastener body contacts said front surface of said at least one sheet of material.

10. The indicating fastener device of claim 9, further comprising a retraction mechanism configured to bias said fastener extension and retention mechanism in a direction that retracts said insertion end of said fastener extension and retention mechanism toward said proximal end of said fastener body so as to clamp said at least one sheet of material between said retention member and said proximal end of said fastener body when said at least one retention member engages said back surface of said at least one sheet of material in retaining relationship at the same time that said proximal end of said fastener body contacts said front surface of said at least one sheet of material.

11. The indicating fastener device of claim 10, wherein said actuator extension extends from said distal end of said fastener body when said insertion end of said fastener extension and retention mechanism is retracted toward said proximal end of said fastener body; and wherein said thickness indicator comprises a graduated scale disposed on a surface of said actuator extension.

12. The indicating fastener device of claim 9, wherein said graduated scale is disposed on a surface of said actuator extension.

13. The indicating fastener device of claim 9, wherein said fastener extension and retention mechanism comprises at least two retention members provided on said insertion end of said fastener extension and retention mechanism.

14. The indicating fastener device of claim 11, wherein said at least one retention member comprises first and second opposing tang segments provided on said insertion end of said fastener extension and retention mechanism; and wherein said at least one extension member comprises first and second extension members, said first extension member being provided between said first tang segment and said actuator extension and said second extension member being provided between said second tang segment and said actuator extension, said first and second extension members being biased toward each other and deflectable away from each other to form a space therebetween; and wherein said indicating fastener device further comprises a separating member received in said space between said first and second extension members, said separating member configured to extend from said proximal end of said fastener body so as to as to be disposed adjacent and between said first and second tang segments when said first and second tang segments engage said back surface of said at least one sheet of material in retaining relationship at the same time that said proximal end of said fastener body contacts said front surface of said at least one sheet of material so that said insertion end of said fastener extension and retention mechanism has an external dimension that is greater than the diameter of said opening defined in said at least one sheet of material.

15. The indicating fastener device of claim 8, wherein said at least one sheet of material comprises a stack up assembly of two or more sheets of material.

16. A method of determining the thickness of at least one sheet of material, said method comprising:
providing an indicating fastener device, said indicating fastener device comprising:
a fastener body having a proximal end and a distal end,
a fastener extension and retention mechanism slidably received within said fastener body and having an insertion end extending from said proximal end of said fastener body and having a retention mechanism provided thereon, and
a thickness indicator configured to indicate a position of said fastener extension and retention mechanism relative to said fastener body;
positioning said insertion end of said fastener extension and retention mechanism within an opening defined in said at least one sheet of material and in operative relationship with said fastener body so that said retention mechanism selectably engages a back surface of said at least one sheet of material at the same time said proximal end of said fastener body contacts a front surface of said at least one sheet of material such that the position of said fastener extension and retention mechanism relative to said fastener body corresponds to said thickness of said at least one sheet of material; and
determining said thickness of said at least one sheet of material from said thickness indicator.

17. The method of claim 16, wherein said at least one sheet of material comprises a stack up assembly of at least two sheets of material.

18. The method of claim 17, wherein said positioning further comprises selectably clamping said at least two sheet materials together between said retention mechanism of said fastener extension and retention mechanism and said proximal end of said fastener body so that substantially no gap exists between said at least two sheet materials of said stack up assembly.

19. The method of claim 18, further comprising disengaging said retention mechanism of said fastener extension and retention mechanism from said back surface of said at least two sheet materials of said stack up assembly; and removing said insertion end of said fastener extension and retention mechanism from said opening defined in said at least two sheet materials of said stack up assembly.

20. The method of claim 19, further comprising selecting a permanent fastener based at least in part on said determined thickness of said at least two sheets of material of said stack up assembly; and assembling said at least two sheets of material of said stack up assembly using said selected permanent fastener.

21. The method of claim 16, wherein said thickness indicator comprises a graduated scale.

22. The method of claim 21, wherein said fastener extension and retention mechanism further comprises an actuator extension extending from said distal end of said fastener body, and wherein said graduated scale is disposed on said actuator extension.
